(19) United States
(12) Patent Application Publication
(10) Pub. No.: US 2008/0243590 A1
(43) Pub. Date: Oct. 2, 2008

(54) METHODS AND SYSTEMS FOR MEASURING EXPOSURE TO MEDIA

(76) Inventor: Michael Rich, Brookline, MA (US)

Correspondence Address: POLSINELLI SHALTON FLANIGAN SUELTHAUS PC, 700 W. 47TH STREET, SUITE 1000, KANSAS CITY, MO, 64112-1802, US

(21) Appl. No.: 12/024,028

(22) Filed: Jan. 31, 2008

Related U.S. Application Data
(60) Provisional application No. 60/898,561, filed on Jan. 31, 2007.

(51) Int. Cl. G06F 17/30

(52) U.S. Cl. 705/10

(57) ABSTRACT

A method for measuring effects of media exposure on a subject is disclosed wherein recall estimate, time-use diary, momentary sampling of the subject during exposure and audio/visual survey are performed and analyzed by determining the attention of the subject to the medium and the effect of the environment on the subject to the medium.

### CROSS REFERENCE TO RELATED APPLICATIONS

This application claims the benefit of U.S. Provisional Application No. 60/898,561, filed Jan. 31, 2007, the contents of which are incorporated herein by reference.

### FIELD OF THE INVENTION

The present invention relates to methods of assessing, measuring, and quantifying media use, multitasking, and background media exposure.

### BACKGROUND OF THE INVENTION

The advertising industry is constantly evaluating the impact of its various forms of communication, i.e. different media, in a world that is consistently exposed to concurrent media usage. Advertisers, for example, are often chartered to developed ways to assess the level at which persons, or potential consumers, are engaged in any particular advertisement transmitted in one medium as the consumers are actively absorbing bits of information from other media. Concurrent media usage from TV to computers to cellular telephones require shared attention on behalf of the person exposed to the media.

With these advances, our media usage and exposure has increased, with 8- to 18-year-olds using media for an average of over 6 hours each day. More than ¼ of that time, youth are multitasking, using two or more media simultaneously, exposing them to an average of 8½ hours of media content daily. More American homes have five or more TVs than have one, 68% of 8- to 18-year-olds have a TV in their bedrooms, and 63% watch TV while eating meals. Investigating the effects of media on the health of adolescents has become critical. Furthermore, certain industries; for example, the media industry, are interested in determining the effects of media so as to better plan for placement of services and other assets. There has been a lack of consensus and acceptance of a system and/or method for assessing the effects of placement of services and other assets.

At present, there is no established standard for assessing media exposure that has an acceptable level of reliability or validity. The vast majority of academic research has used Recall Estimates (RE), self-report by subjects or their parents of the amount of time that they typically use different media, with little information on content and poor reliability. The Arbitron box on which Neilsen and other viewing raters have depended to establish viewership and advertising rates has been rendered obsolete by the ubiquity of televisions in homes and the variety of portable and non-portable platforms on which televisions content is being delivered.

What is needed is an effective method to assess and to measure the level of attention given to any one or more different transmissions of media and to determine what level of attention/awareness is necessary to change knowledge, attitudes, and/or behaviors.

### SUMMARY OF THE INVENTION

The present invention may be directed to a method of analyzing media using data techniques recall estimate, time-use diary, momentary sampling electronic reports, and momentary video sampling surveys. The method of analysis may be used to assess a subject's attention to specific media and the effect of the subject's environment on the subject's attention to specific media. The method of analysis may also be used to measure salience of specific media by measuring a subject's attention or behavior to the specific media and the effect of the subject's environment on the subject's attention or behavior to the specific media. The method of analysis may also be used to assess and predict a subject's behavioral outcomes based on exposure to specific media and the effect on the subject's behavioral outcomes due to the subject's environment.

The present invention may also be directed to a method is also provided herein that may measure salience of a medium comprising (a) performing a recall estimate of a subject exposed to a medium; (b) providing a time-use diary of the activities of subject during exposure to the medium; (c) performing a momentary sampling of the subject during exposure to the medium; and (d) acquiring the complete audio and visual environment of the subject during exposure to the medium, wherein salience of the medium is determined by attention of the subject to the medium and the effect of the environment on the subject to the medium. The data may be collected and analyzed to assess the subject's attention to specific media and the effect of the subject's environment on the subject's attention to the media, and the results may be indicative of the salience of the particular medium to the subject.

The present invention may also be directed to a method for predicting behavioral outcomes based on exposure to specific medium comprising (a) performing a recall estimate of a subject exposed to the medium; (b) providing a time-use diary of the activities of subject during exposure to the medium; (c) performing a momentary sampling of the subject during exposure to the medium; and (d) acquiring the complete audio and visual environment of the subject during exposure to the medium, wherein a behavioral outcome is determined by attention of the subject to the medium and the effect of the environment on the subject to the medium. The behavioral outcome may be related to dietary habits, exercise habits, propensity to express violent behavior, and consumer behavior.

The present invention may also be directed to a method for measuring effects of media exposure on a subject using at least one processor and comprising the steps of generating a first notification to alert the subject to complete a time use diary within a specified period of time, displaying a first form to receive the time use diary data, generating a second notification to alert the subject to record momentary media exposure data, displaying a second form to receive momentary media exposure data, generating a third notification to alert the use to record video data of an environment in which the subject is exposed to media, receiving the video data of the environment, assigning a weighting to each of the time-use diary data, the momentary media exposure data, the video data, and the recall estimate data, and determining a value for a media exposure data, the video data, and the recall estimate data, and determining a value for a media exposure assessment parameter as a function of the assigned weightings. The data may be analyzed by regression analysis. The method may use a hand held computer to randomly signal when the subject's activities are to be recorded in the TUD, and wherein the random signals generated by the handheld computer double in frequency on days in which the subject is signaled to record the activities in the TUD. The method may also measure the salience of the medium as determined by attention of the subject to the medium ad the effects of the environment on the subject to the medium. The method may predict the behavioral outcome based on exposure to a specific medium. The behavior outcome may be dietary habits, exercise habits, propensity to be violent or consumer behavior for example. The method may be used to measure the subject's attention to specific media source in media rich environment. The method may be used to determine the placement of advertising in a specific population.

The present invention may also be directed to a system for measuring effects of media exposure on a subject. The system may comprise a media exposure application executable on a portable computing device. The media exposure application may comprise a notification module to generate a first notification to alert the subject to complete a time use diary (TUD) within a specified period of time, to generate a second notification to alert the subject to record momentary media exposure data, and to generate a third notification to alert the user to record a video of an environment in which the subject is exposed to media. The media exposure application may also comprise a user interface module to generate a first form for display in response to the first notification, to generate a second form for display in response to the second notification, and to generate a third form for display in response to user input, wherein the first form is configured to receive TUD data, the second form is configured to receive momentary media exposure data, and the third form is configured to receive recall estimate data. The momentary exposure application may comprise an assessment application executable on a processing system and configured to receive video data of the environment in which the subject is exposed to the media. The application may comprise a retrieval module to retrieve the TUD data, the momentary media exposure data, and the recall estimate data from the portable computing device and to receive the video data. An assessment module may assign a weighting to each of the TUD data, the momentary media exposure data, the video data, and the recall estimate data and to determine a value for a media exposure assessment parameter as a function of the assigned weightings.

The present invention may also be directed to a system for measuring effects of media exposure on a subject. The system may comprise a portable computing device comprising: a media exposure application executable on the portable computing device. The media exposure application a comprise a notification module to generate a first notification signal to alert the subject to complete a time use diary (TUD) within a specified period of time, to generate a second notification signal to alert the subject to record momentary media exposure data, and to generate a third notification signal to alert the user to record a video of an environment in which the subject is exposed to media. The media exposure application may further comprise an interface module to generate a first form for display in response to the first notification signal, to generate a second form for display in response to the second notification signal, and to generate a third form for display in response to user input, wherein the first form is configured to receive TUD data, the second form is configured to receive momentary media exposure data, and the third form is configured to receive recall estimate data. The media exposure application may further comprise a video capture component to capture video data of an environment in which the subject is exposed to the media. The media exposure application may comprise a processing system computer comprising an assessment application executable on the processing computer. The assessment application a comprise a retrieval module to retrieve TUD data, momentary media exposure data, video data, and the recall estimate data from the portable computing device for storage in a memory; and an assessment module to assign a weighting to each of the TUD data, the momentary media exposure data, the video data, and the recall estimate data and to determine a value for a media exposure assessment parameter as a function of the assigned weighting.

### BRIEF DESCRIPTION OF THE DRAWINGS

FIG. 1 is a block diagram of a media exposure measurement system in accordance with an aspect of the present invention.

FIG. 2 is a block diagram of a media exposure application according to one aspect of the media exposure measurement system.

FIG. 3 is a block diagram of a media exposure assessment application according to one aspect of the media exposure measurement system.

FIG. 4 is a flow chart illustrating a method for collecting media exposure data to assess the effects of media exposure on a subject according to one aspect of the media exposure measurement system.

FIG. 5 is a flow chart illustrating a method of measuring the effects of media exposure on a subject using data collected from Recall Estimate methods, Time Use Diaries, and Momentary Sampling in the form of electronic reports and video surveys. This data is analyzed focusing of the subject's mood/behavior/activity with the media and the influence of the media or environment on the subjects mood.

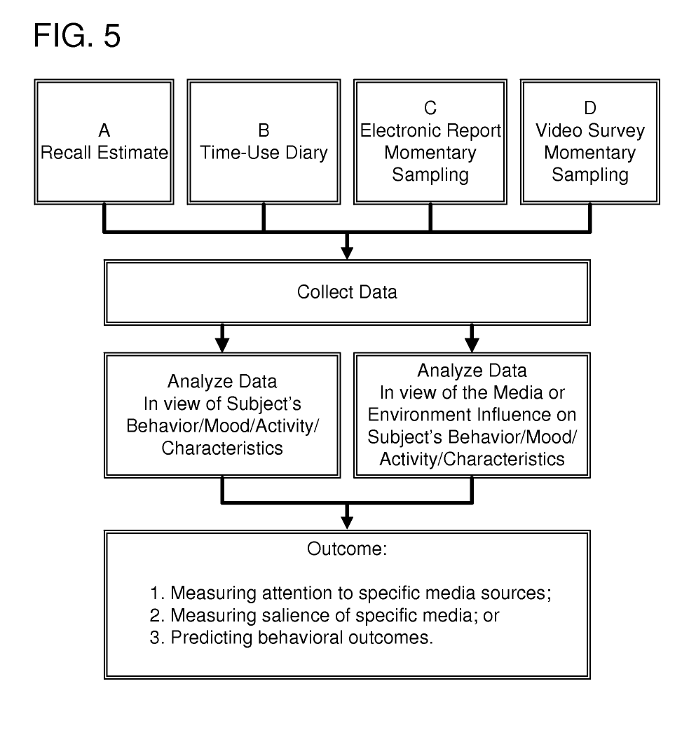

### DETAILED DESCRIPTION

The inventor has made the surprising discovery of an accurate and sensitive method for determining the effect of media on a person. The method combines data collected from Recall estimates (RE), time-use diaries (TUDs), momentary sampling electronic reports (MS-ER), and momentary video sampling surveys (MS-VS) to analyze a person's reaction and interaction with various media. The method analyzes a person's reaction and interaction of various media by focusing on the overall characteristics, mood, behavior, and activity of the person at the time of sampling or in view of a persons behavioral history. The method further analyzes a person's reaction and interaction of various media by considering the effect of the media and person's environment on their mood, behavior and activity with media. This combined methodology allows one to measure any and all media forms and uses and provide the level of sensitivity required to measure duration of exposure, simultaneity, focus of attention, salience of each medium, individual affective state, media content, and exposure context. The method may be carried in various forms and measurement systems. The method has a number of applications in the fields of psychology, advertising, communications, and medicine.

### 1. DEFINITIONS

The terminology used herein is for the purpose of describing particular embodiments only and is not intended to be limiting. As used in the specification and the appended claims, the singular forms “a,” “an” and “the” include plural referents unless the context clearly dictates otherwise.

As used herein, the term “handheld computer” may be any portable computing device, optionally utilizing a small visual display screen for user output and a miniaturized keyboard for user input. For example, in the case of a personal digital assistant (PDA) the input and output may be combined into a touch-screen interface. Other mobile computing devices include laptops and smartphones. Handheld computers may include information appliances; smartphones; personal digital assistants (PDA); cell or mobile phones; personal communicators; and ultra-mobile personal computers.

As used herein, the term “media” may be an avenue of communication where a message is transmitted to a recipient. Media delivery mechanism may diverge dramatically from large widescreen televisions to tiny portable entertainment devices. For example, media may be an electric medium such as television, motion pictures, documentary films, video games, music, Internet, electronic mail, advertising, electronic books, electronic magazines, cell phone messaging, radio and advertising. Media may be a printed medium such as magazines, books, pamphlets, bulletins, newspapers, journals, treatises, advertising boards, bulletins, art, leaflets, packaging, and letters. Media may be through sound medium in advertising, electronic mail, internet, books, public or private speeches, plays, operas, concerts, cd, records, audio tapes, radio, cell phone messaging, telemarketing, newspapers, and personal discussions. Media may be through an in person medium such as performances, advertising pitch, public or private speeches, conversations, symposiums, public sporting events, and concerts.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

### 2. METHOD

Provided herein is a method measuring effects of media exposure on a subject, which may be used to assess a subject's attention to specific media, and may also be used to assess the effect of the subject's environment on the subject's attention to specific media. The method may comprise recording the subject's media exposure, providing the subject's activities, momentarily sampling the subject's activities, and recording the subject's audio and visual environment. The method may measure any and all media forms. The method may use and provide a level of sensitivity required to measure duration of exposure, simultaneously focus attention on the individual affective state, media content and exposure context, and environment around an individual. The method may measure the level of attention given to any one or more different simultaneous transmissions of media. The method may absorb data relating to new and emerging media as well as unexpected applications of existing media technology indoors or outdoors. The method may be repeated one or more times over a period of 1-104 weeks.

a. Data Collection

(1) Recall Estimate

The method measuring effects of media exposure on a subject may use data collected from Recall Estimates (RE). RE methods require a respondent to remember and estimate their activities over a period of time. The period of time may be 1-60 seconds, 1-60 minutes, 1-24 hours, 1-52 weeks, or 1-100 years. Recall estimate (RE) methods may be subject to generalized recall error when respondents are asked to remember and estimate their activities over an average week. Re may impose little burden on subjects. RE may also for easy, quick and inexpensive collection of data. RE may be compared to earlier studies.

RE data may shed light on salience as a mediator of media influence, attention to media, and/or on health/behavior outcomes. It is unclear whether remembering media content remembered after one week has more potent effects, and/or whether subliminal messages are as, or more, influential on health. The RE may comprise an Audio Computer-Assisted Self-Interview (ACASI), which may assess the subject's health status, lifestyle, behavioral patterns, and media use.

REs may however overestimate actual time use. When respondents extrapolate a day's use into a week, they may often choose a day that over-represents the activity in question. For example, if a person watches TV for three hours on most Thursdays but considerably less on other days, they may estimate their weekly use as an inflated 21 hours. Parents may tend to report media use in a socially desirable fashion, overestimating media use that is considered positive (e.g., reading) while underestimating media use that is stigmatized (e.g., TV viewing). RE may related to information most salient to the respondent at the time since RE is based on recall. For example, parents who thought that their children were watching too much TV may overestimate whereas adults for whom there was no media stigma may not register or forgot much of their children's exposure.

(2) Time-Use Diary

The method measuring effects of media exposure on a subject may use data collected from Time Use Diaries (“TUD”). A TUD may be a record kept by the subject of all activities of subject over a period of time. TUDs may be a record a subject activities over a period of time be 1-60 seconds, 1-60 minutes, 1-24 hours, 1-52 weeks, or 1-100 years. The period of time may be every 6-12 hours, or 12-24 hours. The period of time may be 1-7 days. The period of time may be a record kept by the subject or a parent/spouse/friend/associate/health care profession of the subject.

TUDS Diaries may be used extensively as a means of measuring activity without incurring excessive cost or time commitment from respondents. TUDS may be an excellent measure of the duration of activities. TUD methodology may be stable; wording or format variations and may make little difference in the validity of data collected.

TUD data may be used to measure a subject's media use and help to determine the salience of a particular medium and its influence on a subject. TUD may be used to measure a subject's attention to media. TUDs may be used to measure a subject's media use and relate it to academic, health, and behavioral outcomes. For example, TUDs may provide important information on content of media children use by obtaining titles of TV programs being watched and video games being played. TUDs may be much more accurate measures of children's TV viewing than parental estimates, correlating highly (r=0.84) with direct video observations of preschoolers, but less well (r=0.60) with parent RE. TUDs may require the subject to manually enter data into a database for analysis, therefore increasing the chances for transcription errors. Even though recall is more proximal (at the end of a day rather than a week), TUDs, like REs, are self-reported, and thus may be limited by errors of retrieval, telescoping, inference, recency and salience.

TUD may be advantageous over RE. A study of children's TV time showed that both parent REs and media-specific TUDs overestimated actual viewing time observed on video. Test-retest reliability of RE questions on TV and computer use administered to middle school students as part of the Youth Risk Behavior Survey (YRBS) showed correlations of 0.55 to 0.68; a 7-day TUD had correlations of 0.46 for weekday TV viewing, 0.37 for weekend viewing, 0.47 for average viewing over one week, and 0.39 for computer use. A recent study investigating media use and multitasking of adults showed that REs of media use were less than half of what was directly observed and that TUDs, although better, still fell 13% short of actual media use.

TUDS may require significant analytical time and resources. TUDs can be expensive to implement and burdensome to subjects. Youth in the experimental pilot study found daily TUDs “annoying” and “got sick of them.” Data quality may deteriorate over the week. The present invention remedies this deterioration; the TUD records randomly selected exemplar days.

TUDs may be poor at capturing psychological and social contexts of activities, particularly subjects' transient affective states. Difficulties with measuring multiple concurrent activities is the most important limitation of TUDs. When reporting a time period when they performed more than one activity, subjects must choose which activities to record and prioritize them. Prioritization of activities may be less a record of subjects' ever-shifting focus when multitasking than a reflection of what they “should” be doing, e.g. homework over instant messaging. Thus much of the rich detail of children's activities is lost in a TUD. As youth media use becomes more complex and media multitasking more common, this limitation makes TUDs alone insufficient for measuring youth media exposure.

(3) Momentary Sampling—

The method measuring effects of media exposure on a subject may use data collected from momentary sampling. Momentary Sampling (MS) is a method in which the subject is signaled at random intervals during the study period and asked to report their momentary (current) status, which can include activities, contexts, attentional and affective states. Because of the complexity of the contemporary media environment and the dynamic state of a young person's activities, attention and affective state, momentary sampling (MS) may provide a valid measure of the shifting experience of media multitasking.

MS may add ecological validity to the study of the feelings, thoughts, and behaviors of daily life by capturing a representative sample of momentary phenomena, including media use. Completed in “real time,” MS reports may be unaffected by recall bias. MS gathers data on environmental factors that may provide a context for the subject's experience of media, including where they use media and with whom they share it. MS may capture the momentary affect of the subject while using or exposed to media, permitting a better understanding of whether and how affect influences media effects. The large number of repeated MS observations may create a rich, detailed sample of the study subject's momentary activities, contexts, and attention.

MS may be a record a subject activities over a period of time be 1-60 seconds, 1-60 minutes, 1-24 hours, 1-52 weeks, or 1-100 years. The period of time may be every 6-12 hours, or 12-24 hours. The period of time may be 1-7 days. The period of time may be a record kept by the subject or a parent/spouse/friend/associate/health care profession of the subject.

Limitations of MS methods include reliance on self-report (although recall is not a problem, since they are reporting on now), potential for self-selection bias, and possibility that the method influences the phenomena being measured. The present methods have minimized many of the disadvantages associated with momentary sampling, including technical failures and subject burden, retention, and adherence.

MS may be accomplished with two user friendly technologies, momentary sampling-electronic reporting and momentary sampling-video survey. These two technologies may be portable.

(a) Electronic Report

Momentary sampling-electronic reporting (MS-ER) may be a subject responding to a signal and completing a series of fixed questions at each signal. MS-EF may provide limited context, foreground-background exposure, and media content data. MS-ER may use individuals log self-reports in response to random signals during waking hours. MS-ER may examine multitasking with media and other activities, rank focus of attention at that moment, identify “place and people” contexts of media exposure, and explore momentary affect. MS-ER responses may be programmed to record the signal and report times, so it can be programmed to not accept a report if a defined period of time after a signal has elapsed, precluding “stacking” or faking of reports. MS software may use fixed multiple-choice responses and manages skip patterns, avoiding problems with invalid or missing data. Completed reports may not be viewed or altered by the subject. Data may be downloaded from the hand-held computer to the research database, eliminating errors of data entry.

MS-ER may use a hand-held computer, for example a personal digital assistant (PDA), programmed with MS software, so that the same device is used for signaling and reporting. MS-ER on the signaling hand-held computer may examine multitasking with media and other activities, rank focus of attention at that moment, identify “place and people” contexts of media exposure, and explore momentary affect. MS-ER may provide limited context and media content data.

(b) Video Survey

MS-VS may be where a subject shoots a 360° pan of their immediate environment with a video camcorder to capture a comprehensive audiovisual record of all media seen and heard, including passive and background exposures, revealing specific media content (images on TV or computer screens, song lyrics heard, background media) as well as the subject's spoken description of what they are watching and/or listening to.

Furthermore, previous experience collecting subject-created video data shows that it is unfiltered by the recording medium and limited in editing by the subject who feels in control and safe.

Video surveys (VS) of the subject's immediate audiovisual environment can disclose context, foreground-background exposure, and media content, but cannot reveal either the focus of the subject's attention or his/her affective state.

(4) Combining Data from RE, TUD, MS-ER and MS-VS;

The method measuring effects of media exposure on a subject combines recall estimate (RE), time-use diaries (TUDs), and momentary sampling (MS), in two forms, Electronic Report (MS-ER) and Video Survey (MS-VS) to measure any and all media forms and uses and provide the level of sensitivity required to measure duration, simultaneity, attention, affect, media content, and exposure context, including foreground-background exposure.

The method measuring effects of media exposure on a subject may be designed to utilize the unique strengths of and synergies between established data collection methods for collecting data on media use and exposure, while recognizing and compensating for their limitations. For example, TUD and RE may provide short and long term recall of media exposure; the intensity and longevity of memory may indicate salience of media exposure. TUDs may be used for media use duration and content and MS for content and context data. MS may address TUD's limitations of recall, subject focus on concurrent activities, and contextual information in formats (MS-ER and MS-VS) that are less burdensome, even enjoyable for subjects. Potential transcription errors may be decreased by double entry of TUD data and can be evaluated by comparing against the increased number of MS reports for TUD days.

The method measuring effects of media exposure on a subject may comprise (a) a Recall Estimate (RE) of the subject's interaction with media and use of audio computer-assisted self-interview (A-CASI) in which the subject confidentially responds to a series of questions generated in audio and print forms by a laptop computer; (b) employing a media exposure measurement system as described below, to randomly signal the subject carrying the system to complete a time use diary (TUD) over a particular period during a randomly selected weekday and weekend day; (c) further employing the media exposure system to randomly signal the subject carrying the system to complete standardized questions of a Momentary Sampling-Electronic Report (MS-ER) and to record a Video Survey (MS-VS) of their immediate environment, describing what the subject is doing, where and with whom they are doing it, and revealing any background exposures of which the subject may not be aware; (d) at the completion of the above data collection period, the subject completes a second RE using A-CASI, recalling his/her media use, the content of the media, and context in which the subject was exposed to the media over the data collection period. REs using A-CASI may be made at subsequent points in time after the defined period, thus assisting whether measured media use patterns and effects are lasting.

The method may effective assess and measure the level of media attention by youths. This Measurement of Youth Exposure (MYME), a method which may effectively assess and may measure the level of attention given to any one or more different simultaneous transmissions of media, and may be flexible enough to absorb data relating to new and emerging media as well as unexpected applications of existing media technology, indoors or outdoors. Recall estimate (RE), time-use diaries (TUDs), and momentary sampling (MS) in two forms, momentary sampling-electronic report (MS-ER) and momentary sampling-video survey (MS-VS), may be combined into a single method to measure any and all media forms and uses and may provide the level of sensitivity required to measure duration of exposure, simultaneity, focus of attention, salience of each medium, individual affective state, media content, and exposure context.

(5) Analysis of Data—

The method may also analyze the data collected from the TUD, RE, MS-ER, and MS-VS. The analysis may include calculating various media exposure assessment parameters. The media exposure assessment parameters may include determining and statistically weighing a subject's behavior, activity, characteristics, feelings, disposition and/or mood at the time of sampling or taking into account a history of the subjects behavior, activity, characteristics, feelings, disposition and/or mood at particular times. The media assessment parameters may analyzes a person's reaction and interaction of various media by focusing on the overall characteristics, mood, behavior, and activity of the person at the time of sampling or in view of a persons behavioral history. The media exposure assessment parameters may further analyzes a person's reaction and interaction of various media by considering the effect of the media and person's environment on their mood, behavior and activity with media. The media exposure assessment parameters may include determining and statistically weighing social interaction with others and/or habits of the subject. The media exposure assessment may also include whether the media or different forms of media applied to the subject's environment alter the subject's behavior, feelings, disposition and/or mood. The media exposure assessment may also include whether the media or different forms of media applied to the subject environment caused an alteration in the subject's social interaction with others and/or habits of the subject. The media exposure assessment parameters may include determining how the subject interacts with the environment under the veil of media. The media exposure assessment parameter may include determining and statistically weighing which type of medium the subject focuses upon in an environment of a single or multiple media channels. The media exposure assessment may also include the level of multitasking different forms of media by a subject. The media exposure assessment may include determining and statistically weighing a particular media's impact on the subject's environment. The impact of the environment may be the level of sound emitting from a particular medium, level of light and electronic signaling from medium, the nature of the message from the medium, the required interaction by the subject with the medium, and the length of time the subject exposes themselves to the media. The calculation of these various media exposure assessment parameters may include weighted statistics, regressions analysis, or other statistical means.

(6) Protocols Post Collection and Analysis of Data

Subject may meet with a research coordinator (RC) to return the media exposure system and completed TUDs. At that time, subjects complete the confidential A-CASI Completion Assessment. Subjects are asked to recall their media use, content and context, as well as activities on the random weekday and weekend day for which they completed TUDs. Each subject's randomly assigned TUD weekday and weekend day will be programmed into their Completion Assessment and media exposure system at study initiation. When subjects are asked by A-CASI to enter details on the media they used via keyboard, they will have unlimited data entry capability. Subjects will also be asked for their observations on the feasibility, acceptability, strengths and difficulties of the methods used to collect the data. Meanwhile, the RC will upload the subject's MS-ER data to the study laptop, screen the MS-VS tape for number of recordings, and calculate MS-ER and MS-VS response rates. The completion assessment should take no longer that approximately 30 minutes to complete.

Follow-up studies may be conducted to repeat measurement of media exposure and/or health risk behaviors. For example, two weeks (plus or minus one week) after the conclusion of the time period assigned to data collection, subjects may repeat the full protocol. Subject may also have their heights and weights measured and asked to complete a follow up questionnaire on media exposures and health risk behaviors at any point after the conclusion of the primary data collection (e.g. 6 months, 1 year, 2 years).

Data analysis may be achieved qualitatively and/or quantitatively. For qualitative analysis, software programs, such as NVivo (QSR International Pty Ltd.), are useful in extracting meaning from the information derived from the present invention. Analysis and interpretation of the information and data of the present invention may depend from the types of research questions one seeks to answer by employing the presently described methods.

### 3. DEVICES TO COLLECT AND ANALYZE DATA

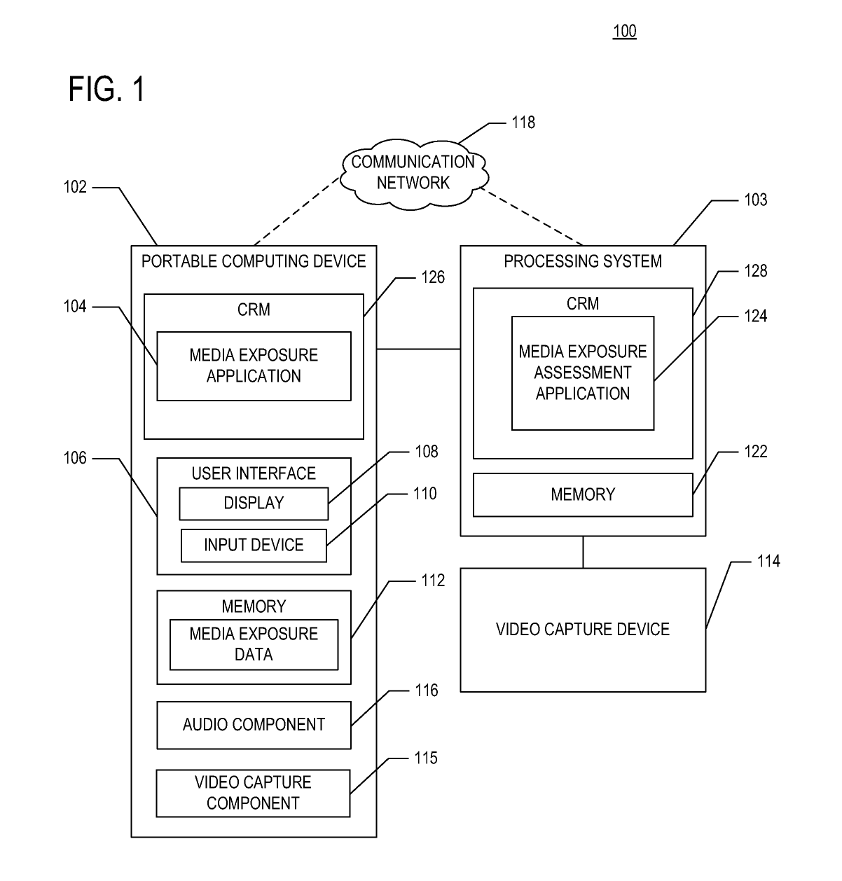

The method measuring effects of media exposure on a subject may be performed using a media exposure measurement system. FIG. 1 depicts an exemplary aspect of a media exposure measurement system (MEMS) 100. The MEMS 100 enables a subject to collect media exposure data via a portable computing device 102 and to transfer the collected media exposure data to a processing system 103. The portable computing device 102 may be a personal digital assistant, a smart phone, a cell phone, a laptop computer, or any other portable computing device. The processing system 103 can be another laptop computer, a workstation computer such as a personal desktop computer, or a server computer, or any other computer processing device.

The portable computing device 102 may comprise a media exposure application 104 that comprises executable modules or instructions that enable the portable computing device 102 to notify a subject to enter and/or to collect media exposure data such as TUD data, MS-ER data, MS-EV data, and/or the recall estimate data. For example, the media exposure application 104 may be configured to generate one or more audio and/or visual alerts to alert the subject to collect media exposure data.

A user interface (UI) 106 enables the subject to view media exposure data collection instructions and to issue processing commands. In one example, the UI 106 may comprise a display 108, such as a screen, for viewing media exposure data collection instructions and an input device 110, such as a keyboard or a pointing device (e.g., mouse, trackball, pen, touch pad, or other device), for allowing the subject to enter media exposure data. The UI 106 may be configured to display one or more input forms via the display 108. The input forms may enable the subject to input media exposure data.

The portable computing device 102 may comprise a memory 112 for storing media exposure data. For example, the memory 112 comprises one or more files each comprising media exposure data.

A video capture device 114 may allow the subject to record video data comprising the audio and visual media to which they are exposed. Although the portable computing device 102 and the video capture 114 are illustrated as separate components, the portable computing device 102 may comprise a video capture component 115 configured to record the video data.

The portable computing device 102 and video capture device 114 may be configured to transfer the collected media exposure data and video data, respectively, to the processing system 103 for processing via a wired or wireless communication link. For example, the portable computing device 102 and the video capture 114 may transfer data to the processing system 103 via a wired connection such as a USB connection, a FireWire connection, or any other suitable wired connection. As another example, the portable computer device 102 and video capture device 114 may communicate with the processing system 103 via a Gigabit Ethernet link, IEEE 802.11 link, Ultra-Wide Band (UWB) link, or any other suitable wireless communication link.

The portable computing device 102 may be configured to communicate with the processing system 103 via a data communication network 118. In this example, the data communication network 118 may be the Internet (or the World Wide Web) that facilitates the transfer of data between the portable computer device 102 and the processing system 103. However, the teachings of the media exposure measurement system 100 may be applied to any data communication network.

The portable computing device 102 and the processing system 103 may communicate data among themselves using a Wireless Application Protocol (WAP), which is a protocol commonly used to provide Internet service to digital mobile phones and other wireless terminals. Alternatively, the portable computing device 102 and the processing system 103 may communicate data among themselves using a Hypertext Transfer Protocol (HTTP), which is a protocol commonly used on the Internet to exchange information between clients and servers.

a. Additional Components for Analyzing Media Exposure Data

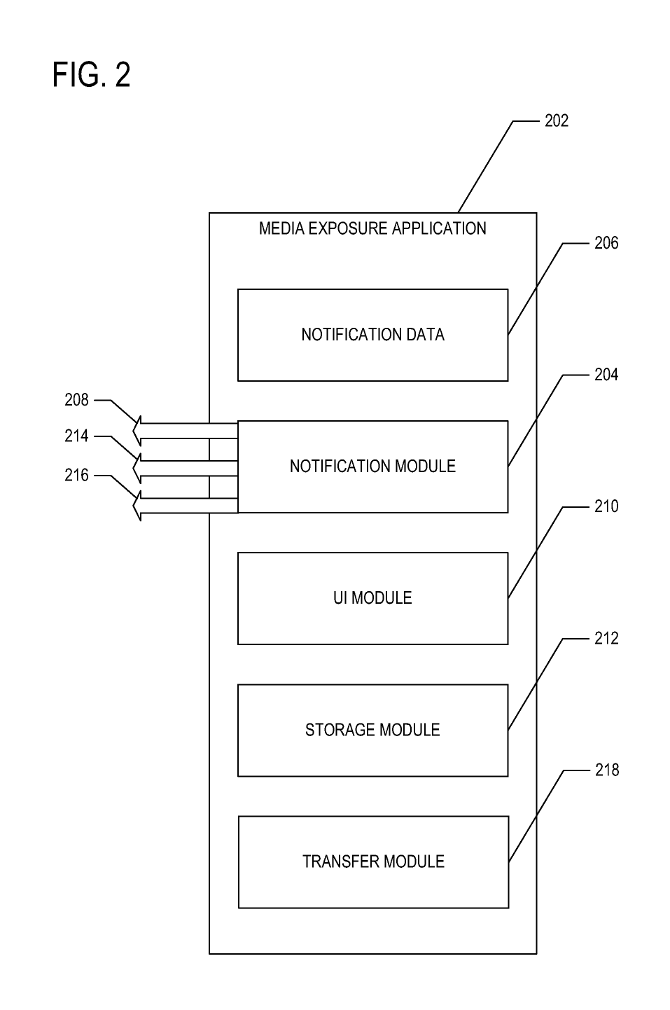

FIG. 2 depicts an exemplary media exposure application 202 (e.g., media exposure application 104) according to one aspect of the MEMS 100. The media exposure application 202 comprises modules that enable the portable computing device 102 to notify the subject to enter and/or collect media exposure data.

A notification module 204 may be configured to retrieve notification data 206 for the particular subject using the portable computer device 102 and to generate notification signals, or notifications, to alert the subject to initiate the collection or recording of media exposure data. For example, the notification module 204 retrieves notification data 206 comprising a start date and designated start time for an upcoming period of time for completing the TUD. The notification module 204 then generates a first notification signal 208 on the start date at the designated time. The portable computing device 102 comprises an audio component 116 such as a speaker that generates an alert in response to the first notification signal 208. The alert may be an audible alert, visual alert or other alert (e.g., “vibrate” on a phone PDA).

A UI module 210 may be configured to generate a TUD message for display on the display 108 of the portable computing device 102 in response to the first notification signal 216. For example, the TUD message may comprise a text message that specifies the start time and ending time of the TUD period. As described in the example above, during the TUD period, the subject may record each of his or her activities, the media the subject used, the content of those media, and the subject's observations onto a matrix divided into fifteen-minute segments. The matrix may be a non-electronic document such as paper document. Alternatively, the UI module 210 may be configured to generate an electronic document such as a TUD form for display on the display 108 of the portable computing device 102 in response to the first notification signal 208. After the subject has completed TUD data entry into the TUD form, a storage module 212 stores the TUD data in the memory 112.

The notification module 204 may be further configured to generate other alert signals at random intervals. For example, the notification module 204 may be configured to randomly generate a second notification signal 214 when a MS-ER is to be completed and to generate a third notification signal 216 when a MS-EV is to be completed. The audio component 116 generates audible alerts in response to the second and third notification signals 214, 216.

The UI module 210 may be configured to generate a MS-ER form for display on the display of the portable computing device 102 in response to the second notification signal 214. For example, the MS-ER form may comprise entry fields for the subject to record and assess the general content of media to which the subject is being exposed at the time the audible alert is generated in response to the second notification signal 214. The entry fields on the MS-ER form may also allow the subject to rank the subject's momentary focus of attention and affects as well as input contextual data including location, companions, thoughts, and feelings. After the subject has completed MS-ER data entry into the MS-ER form, the storage module 212 stores the MS-ER data in the memory 112.

The UI module 210 may be configured to generate a MS-EV message for display on the screen of the portable computing device 102 in response to the third notification signal 212. The MS-EV message comprises, for example, a text message requesting the subject to complete the momentary sampling-video survey by collecting video data using the video capture device 114 or a video recording function of the portable computing device 102.

The subject may use the UI 106 to define typical hours of sleep in advance. This information may be stored in the memory 112 and the portable computing device 102 will not generate alerts during those times.

The UI module 210 may be configured to generate a recall estimate form for display on the screen of the portable computing device 102 in response to input from the subject. For example, the UI component 210 may be to generate an enter recall data option button (not shown) for display on the display 108 of the portable computing device 102. The subject may use the UI 106 to select the enter recall data option button to view the recall estimate form. The recall estimate form may comprise entry fields for the subject to record information he or she recalls about their media use. After the subject has completed recall data entry into the recall estimate form, the storage module 212 stores the recall data in the memory 112. From the above description, it may be seen that in at least one aspect, each of the TUD data, the MS-ER data, MS-EV data, and/or the recall estimate data can be collected via the portable computing device 102. In the alternative, each of the TUD data, the MS-ER data, MS-EV data, and/or the recall estimate data may be collected via other techniques (e.g., manually via pen and paper).

A transfer module 218 may be configured to transfer the collected media exposure data to the processing system 103 for processing in response to a transfer request received via input from the subject. For example, the UI component 210 can generate a transfer option button (not shown) for display on the display 108 of the portable computing device 102. The subject can use the UI 106 to select the transfer option button to generate the transfer request. Alternatively, the transfer request may be automatically generated in response to a detected wired or wireless communication between the portable computing device 102 and the processing system 103

Referring back to FIG. 1, the processing system 103 comprises a memory 122 for storing the media exposure data transferred from the portable computing device 102. The processing system 103 also comprises a media exposure assessment application 124 (“assessment application”) that comprises executable modules or instructions to determine various media exposure assessment parameters.

b. Methods for Using the Media Exposure Measurement System

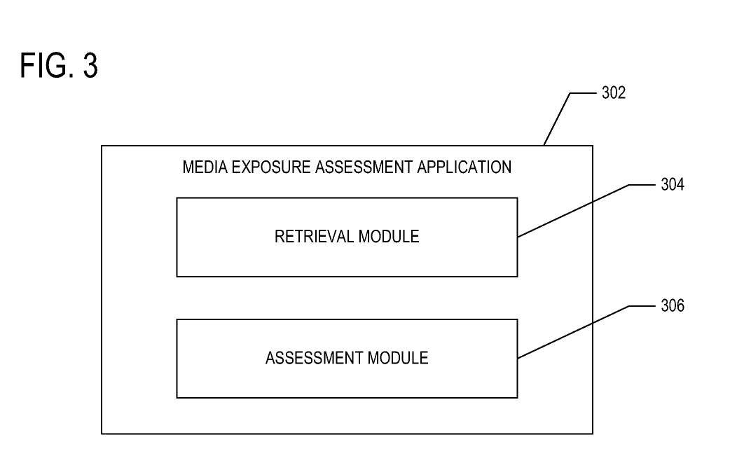

FIG. 3 depicts an exemplary assessment application 302 (e.g., assessment application 124) according to one aspect of the MEMS 100. The assessment application 302 comprises modules that enable the processing system to analyze the TUD data, MS-ER data, MS-EV (e.g. video data), and the recall estimate data, to calculate various media exposure assessment parameters for display.

A retrieval module 304 may be configured to receive the media exposure data from the portable computing device 102 and/or the video capture device 114. The retrieval module 304 may also be configured to store the received media exposure data in the memory 122.

An assessment module 306 may be configured to calculate values or scores for various media exposure assessment parameters. The media exposure assessment parameters comprise, for example, attention to specific media source, salience for specific media, and predicted behavior outcomes. The assessment module 306 may calculate assessment parameters by assigning statistical weighting to each of the various types of collected media exposure data. For example, the appropriate weighting may be determined by comparing historical TUD data, MS-ER data, video data, and the recall estimate data to historically observed behaviors regarding how media effects behavior and/or how the environment effects attention to media. By this comparison process, the preferred weighting of each of the various data types may be determined.

Weighting values may be stored in the memory 122 of the processing system 103 and are later retrieved by the assessment module 306 and applied to the TUD data, MS-ER data, MS-EV (e.g. video data), and the recall estimate data for a particular subject in order to determine values or scores for the media exposure assessment parameters. For example, TUD data may be assigned a weighting value of 35%, MS-ER data may be assigned a weighting value of 20%, MS-EV (e.g. video data) may be assigned a weighting value of 25%, and the recall estimate data may be assigned a weighting value of 20%. This example is for illustration purposes only and is not intended to limit and/or define a range of weightings that are applied to the collected media exposure data.

The collection of the media exposure data and the assessment of the collected media exposure data is described as occurring separately via the portable computing device 102 and the processing system 103, it is contemplated that the portable computing device 102 can be configured to collect and assess media exposure data.

The portable computing device 102 and processing system 103 typically have at least some form of computer readable media (e.g., CRMs 126, 128). Computer readable media may include volatile media, nonvolatile media, removable media and non-removable media, may also be any available medium that may be accessed by the general purpose-computing device. By way of example and not limitation, computer readable media may include computer storage media and communication media. Computer storage media may further include volatile, nonvolatile, removable and non-removable media implemented in any method or technology for storage of information such as computer readable instructions, data structures, program modules or other data. Communication media may typically embody computer readable instructions, data structures, program modules, or other data in a modulated data signal, such as a carrier wave or other transport mechanism and include any information delivery media. Those skilled in the art will be familiar with the modulated data signal, which may have one or more of characteristics set or changed in such a manner that permits information to be encoded in the signal. Wired media, such as a wired network or direct-wired connection, and wireless media, such as acoustic, radio frequency, infrared, and other wireless media contemplated by the MEMS 100, are examples of communication media discussed above. Combinations of any of the above media are also included within the scope of computer readable media discussed above. The portable computing device 102 or processing system 103 may include or be capable of accessing computer storage media in the form of removable and/or non-removable, volatile and/or nonvolatile memory.

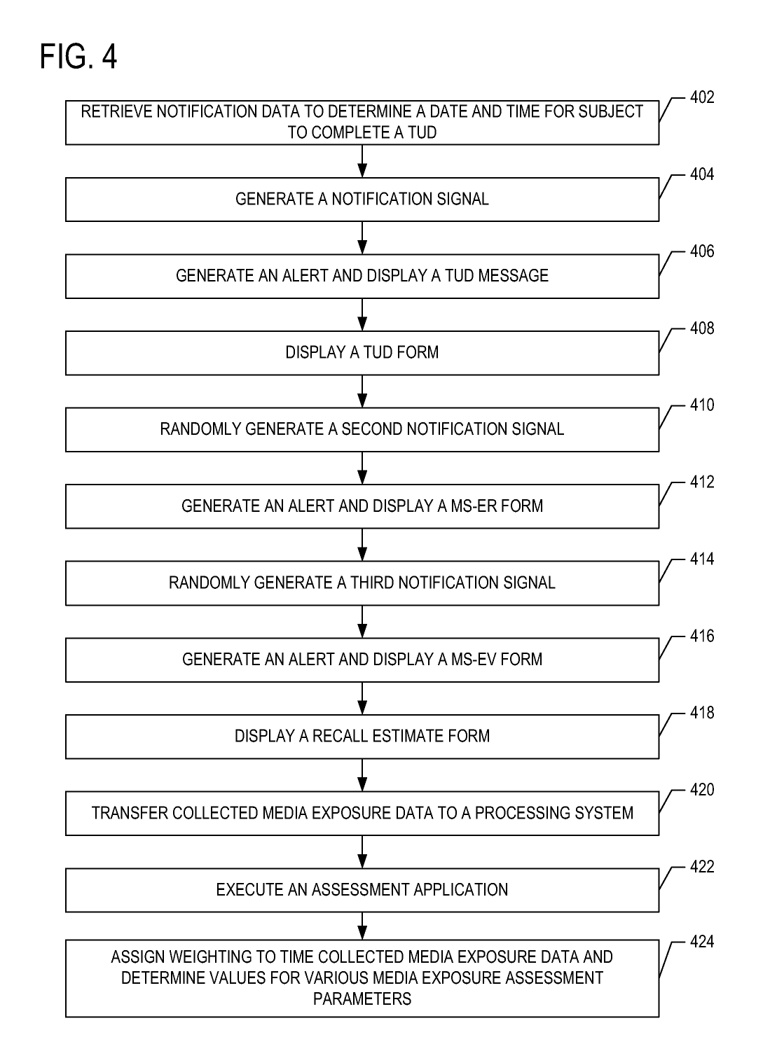

FIG. 4 illustrates a method for collecting media exposure data to assess the effects of media exposure on a subject according to an aspect of the MEMS 100. At 402, the portable computing device 102 may execute the media exposure application 104 and retrieves notification data to determine a date and time to notify the subject of a period of time to complete the TUD. The media exposure application 104 may generate a first notification signal 208 at the determined date and time at 404. At 406, the portable computing device 102 may generate an alert (e.g., beep, blinking light or vibrate) and displays a TUD message in response to the first notification signal 208. As described above, the TUD message may comprise a text message that indicates the start time and ending time of the TUD period. The media exposure application 104 then generates a TUD form for display on the display 108 at 408.

At 410, the media exposure application 104 randomly generates a second notification signal. The portable computing device may generate another alert and displays a MS-ER form on the display 108 in response to the second notification signal at 412. At 414, the media exposure application 104 may randomly generate a third notification signal. The portable computing device 102 may generate another-alert and displays a MS-EV message on the display 108 in response to the third notification signal at 416.

Optionally at 418, the media exposure application 104 may generate a recall estimate form for display on the display 108 of the portable computing device 102 in response to input from the subject. For example, the subject may use the UI 106 to select a enter recall data option button to view the recall estimate form and to enter recall estimate data into entry fields to record information he or she recalls about their media use.

At 420, the media exposure application 104 may transfer the collected media exposure data to the processing system 103 for processing in response to a transfer request received via input from the subject. At 422, the processing system may execute the assessment application 124. The assessment application 124 may assign weighting values to the TUD data, MS-ER data, MS-EV (e.g. video data), and the recall estimate data to determine values or scores for various media exposure assessment parameters at 424. As described above, the media exposure assessment parameters may comprise attention to specific media source, salience for specific media, and predicted behavior outcomes.

### 4. SUBJECT

The subject may be a person who is randomly selected for study, or may meet specific characteristics that make the subject of particular interest for study. The subject may be of a particular demographic group, which may be determined by gender, age, race, ethnicity, social class, economic background, occupation, educational background, or location of residence. The demographic group may be of particular importance for advertising or social study. The subject may reside in a particular media market, such as a designated marketing area. The subject may be studies in any location, such as in a controlled or uncontrolled environment. For example, the environment may be the subject's home or work, or a clinic.

### 5. APPLICATIONS OF METHOD

a. Behavioral Outcomes

The method measuring effects of media exposure on a subject may be used to predict behavioral outcomes based on exposure to specific media. The behavior outcome may be alteration in exercise habits, social activity, educational and self study habits, and monetary habits. The behavioral outcome may be increase propensity to commit violent physical or verbal acts, resist authority, increased thoughts and acts that address purient interests, smoking habits, sedentary behavior, increase aggressive acts, attention disorder, sleeping habits, exercise habits, social activity, gambling habits, spending habits, and shopping habits. The method may be used to examine sexual behavior. The method may be used to predict substance abuse such as of drugs or alcohol. The method may be used to predict eating habits, such as unhealthy eating, or sedentary behavior and propensity to become obese. The behavior outcome may also be sleeping habits, exercise habits, social activity, consumerism, such as shopping or spending habits.

b. Health Status

The method measuring effects of media exposure on a subject may be used to quantify some measurement of health. The measurement of health may be the indicative of the subject's activity level, exercise level, amount of sleep, caloric intake, weight, waist circumference, adiposity, bone mass density, or blood pressure. The measurement may also be of a biological marker from blood or urine. The marker may be cholesterol, low density liproprotein, triglycerides, or other cardiovascular disease marker. Health status may also be measured by the level of intake of alcohol or substances, such as prescription or illicit drugs. Health status may also the level of depression, well-being, mental diseases such as bi-polar or schizophrenia or pain felt by the subject over certain time periods.

c. Advertising Placement

The method may be used to determine the placement of advertising in a specific population, or to help guide decisions about strategic placement of advertising in a specific population. The method may also be used to determine the type of advertising that may gain a significant level attention, such as via the Web, or on television or radio. The method may also be used to analyze the behavior of particular demographic groups, or to compare behaviors between demographic groups. The method may be used to determine what is a preference of media for a particular group or demographic group of subjects. The method may be used to determine a subject's propensity to interact and be attracted to particular forms of media. The method may also determine the salience of a particular media to a subject, a particular demographic group, and area. The method may be used to determine the popularity and attraction of a particular medium.

The present invention has multiple aspects, illustrated by the following non-limiting examples.

### EXAMPLE 1

### Measurement of Youth Exposure

The following example demonstrates use of the method for measuring media exposure in teenaged subjects. Subjects were recruited from an urban hospital-based primary care clinic to obtain ≧3 participants of each sex in pre-teen (10-12 years), early teen (13-15) and late teen (16-18) age groups. Participants were asked to implement 4 media exposure data collection methods: recall questionnaire (RQ), time-use diary (TUD), and two momentary sampling methods, electronic reports (MS-ER) and video surveys (MS-VS). Upon enrollment, participants completed RQ₀ for the previous weekday's exposure to television, videogames, music, phone, computer, and print. Over one week, subjects completed TUDs of their activities, as well as MS-ESs and MS-VSs of current media exposure in response to random alarms from a PDA. At the end of the week, participants completed RQ₁. Descriptive statistics were calculated and findings among methods were compared.

Eleven of 19 participants completed all four methods. Pre-teens accounted for five out of 8 incompletes. When instruction was improved, eight of nine participants completed all methods. Mean total media exposure was 10.5 hours/weekday (h/WD) at RQ₀, and was 17.9 h/WD and 13.6 h/weekend day (h/WE) at RQ₁. TV exposure was greatest, with 3.5 h/WD at RQ₀, and 6.2 h/WD and 6.8 h/WE at RQ₁. All exposure times increased at RQ₁. TUDs showed mean total media exposure as 8.4 h/WD and 9.5 h/WE. TV exposure was greatest, with 3.4 h/WD and 4.0 h/WE. TUD-recorded exposures were less than RQs for all media. Six hundred and fifty-eight MS-ERs and 135 MS-VSs were collected. Comparing MS-ERs, which asked participants to rank their attention to media activities, to MS-VS, which created an audiovisual record of actual exposure, there was 85% agreement on TV, 86% on music and print, 77% on videogames, 94% on computer, and 82% on phone exposure. In comparing exposures across methods, 63% of the time when TUD showed no TV, both MS methods showed TV to be on, and 87% of the time when TUD showed TV on, both MS methods agreed.

This example demonstrates that the method for measuring media exposure was feasible with teens. Recall provided information on total media exposure and on possible reactivity to the act of reporting, but may have overestimated exposure relative to TUDs. TUDs did not detect passive and multiple simultaneous exposure as well as MS methods. MS-ER specifically measured media to which participants were paying attention, and MS-VS detected passive exposure. The results suggest that the multiple methods employed in the method of measuring media exposure complement each other to address the complexity of exposures in the saturated, multitasking media environment of today's adolescents.

### EXAMPLE 2

### Data Management and Quality Control

The study handheld computers will be synced with the research laptop at each subject's Completion Assessment visit and the MS-ER data uploaded. The data will be converted from an ASCII file into Microsoft Excel. Each subject's MS-ER data file for will be coded and merged into a single MS database. The MiniDV videotapes will be dubbed to VHS tape. The RA will screen and log the VHS tapes, noting media exposure context, all foreground (active use) and background (heard from other room or seen in distance) media exposure and content of the media observed. These data will be coded and entered into Microsoft Excel to be merged time synchronously with the MS-ER data. The TUD data will be double-entered into Microsoft Excel and merged time synchronously with the MS-ER and MS-VS data. The A-CASI data will be uploaded into a Microsoft Excel file immediately after subjects complete each A-CASI assessment. Once both are collected for a subject, the Baseline and Completion Assessments will be merged. The Microsoft Excel databases will be imported into SAS for analysis.

Quality Control. A primary investigator (PI) will oversee all research activities to ensure adherence to recruitment, consent, data collection and management procedures, following a study manual of operations. Research Coordinator (RC) training will involve discussion of study procedures, observation of a RC conducting the protocol, feedback on performance, and completion of human subjects training. The study staff will meet weekly to review study conduct and progress.

At the completion visit, the RC will review each subject's MS data for quality and completeness. The RC will determine the number of random signals sent, number of random reports completed, and number of video recordings. A random signal response rate and recording rate will be calculated. If the response rate is low, the RC will review the reasons for this with the subject. The RC will review response data with the PI on a weekly basis. Consistent problems with low response rate or low recording rate will be discussed and strategies to address the problems will be implemented promptly. TUD data will be double-entered to identify and promptly resolve data entry errors. The use of A-CASI and MS technology will eliminate errors associated with data entry and completeness. Subjects' data will be saved to (A-CASI) or uploaded (MS) into a data management computer in the field and backed up daily on a password-protected secure research server.

### EXAMPLE 3

### Data Analysis

Power. To achieve our first aim, to assess the feasibility and acceptability of the present invention for measuring media use and exposure in adolescents, we will use both descriptive and inferential statistical procedures. For the descriptive procedures, we will employ measures such as percents to characterize the proportion of subjects who enroll, who comply with different measurement procedures, and who drop out. We expect to enroll a total of 120 adolescents for the first assessment and retain a minimum of 110 for the second assessment. If we assume the sample size of 120 adolescents from the baseline assessments, we will be able to estimate these percentages to within 8.9 percentage points with 95% confidence. A sample of 110 reduces precision only slightly to 9.3 percentage points with 95% precision. For the inferential procedures we propose to make group comparisons with respect to sociodemographic characteristics using t-tests and chi-square tests of independence. Power for these comparisons will depend on the distribution of the sample into the two groups, with maximum power achieved when the groups are balanced. In the case of balanced groups, 120 subjects provide 80% power to detect differences corresponding to an effect size of 0.52 standard deviation units. In the most extreme case where we are comparing 110 subjects in one group to 10 in the other, we have 80% power to detect effect sizes of 0.93 standard deviation units. Differences of this magnitude are considered to be of medium to large magnitude.

Our second aim is to assess the reliability and validity of the measurement procedures. The multi-trait multi-method matrix (see below) requires computation of correlation coefficients across different behaviors and different assessment methods. Assuming a sample size of 120, we will be able to estimate correlations to within a value of r=0.14 with 95% confidence. In terms of testing against the null hypothesis of no reliability or validity, i.e., r=0, we will have 80% power to detect correlations of r=0.26 or larger.

Our third aim is to determine the predictive validity of media use and exposure using the present invention. For this aim we will construct prediction models using regression analysis. We expect to have at least 100 of the original 120 subjects at the one-year follow-up. For a single covariate, a sample of 100 will give 80% power to detect increases in the proportion of the outcome variance of 7.4%. For models with existing predictors that explain 5% to 20% of the variance, we have 80% power to detect the proportion of the variance between 6% and 7%.

### EXAMPLE 4

### Feasibility and Acceptability

The feasibility and acceptability of the present invention will be evaluated using a combination of descriptive and inferential statistical procedures. We will use descriptive analysis of the subjects' characteristics and comparisons of subjects with nonsubjects using t-tests and chi-squared tests of independence. Compliance with the assessment procedures and loss-to-followup will be assessed at each time point. Compliance will involve different criteria for each of the four assessment methods of one embodiment of the present invention. For TUD, we will characterize the percent of subjects who provide complete data for each day's assessment and analyze the patterns of data completion across the 24 hour time periods. For MS-ER, we will characterize the percent of prompts that elicit a response within the defined time frame and the number of items on the momentary questionnaires that are answered. We will also analyze the response patterns and perform logic checks to determine whether subjects are providing valid responses. For MS-VS, we will determine the percent of subjects who provided video surveys as scheduled and the percent who performed the videotaping exercise correctly. In addition to measuring compliance, we will also assess the sociodemographic characteristics of the subjects who drop out prior to completion of the study. Drop out will be defined relative to several study time points, including drop out prior to completion of the first data collection, prior to initiation of the second data collection, prior to completion of the second data collection and prior to the one-year follow-up. Comparisons between subjects who complete the study and those who drop out will be made using t-tests and chi-square test of independence. Multivariate logistic regression models will be constructed to identify independent variables associated with compliance and dropping out. Dichotomous compliance and compliance variables will be regressed on sociodemographic characteristics obtained at baseline. Model building will be conducted with backward elimination using the AIC criterion. This information will help determine the characteristics of patients that comply with study procedures and those who are retained in the study. This, in turn, will help identify the types of patients who may require special attention to minimize attrition and improve compliance.

In a pilot study, youth were recruited from an urban hospital-based primary care clinic to obtain ≧3 subjects of each sex in pre-teen (10-12 years), early teen (13-15) and late teen (16-18) age groups. Subjects were asked to implement the herein described four media exposure data collection methods (recall questionnaire (RQ), time-use diary (TUD), and 2 momentary sampling methods, electronic reports (MS-ER) and video surveys (MS-VS). On enrollment, subjects completed RQ0 for the previous weekday's exposure to TV, videogames, music, phone, computer, and print. Over 1 week, they completed TUDs of their activities, as well as MS-ERs and MS-VSs of current media exposure in response to random alarms from a handheld computer. At the end of the week, subjects completed RQ1. Descriptive statistics were calculated and findings among methods compared. 11 of 19 subjects completed all 4 methods; preteens accounted for 5/8 incompletes. When instruction was improved, 8/9 subjects completed all methods. Mean total media exposure was 10.5 hours/weekday (h/WD) at RQ0; 17.9 h/WD and 13 hours/weekend day (h/WE) at RQ1. TV exposure was greatest, 3.5 h/WD at RQ0; 6.2 h/WD and 6.8 h/WE at RQ1.

All exposure times increased at RQ1. TUDs showed mean total media exposure as 8.4 h/WD and 9.5 h/WE. TV exposure was greatest, 3.4 h/WD and 4.0 h/WE. TUD-recorded exposures were less than RQs for all media. 658 MS-ERs and 135 MS-VS were collected. Comparing MS-ERs, which asked subjects to rank their attention to media activities, to MS-VS, which created an audiovisual record of actual exposure, there was 85% agreement on TV, 86% on music and print, 77% on videogame, 94% on computer, and 82% on phone exposure. Comparing exposures across methods, 63% of the time TUD showed no TV, both MS methods showed TV to be on; 87% of the time TUD showed TV on, both MS methods agreed.

Based upon the foregoing data, the multimodal method of implementing the four media exposure data collection methods is feasible with teens, for example. Recall provided information on total media exposure and on possible reactivity to the act of reporting, but may have overestimated exposure relative to TUDs. TUDs did not detect passive and multiple simultaneous exposure as well as MS methods. MS-ER specifically measured media to which subjects were paying attention; MS-VS detected passive exposure. The results suggest that the multiple methods of measure youth media exposure complement each other to address the complexity of exposures in the saturated, multitasking media environment of today.

### EXAMPLE 5

### Reliability and Validity

To assess the reliability and validity of the present invention, we will construct a multi-behavior multi-method matrix (MBMM) of reliability and validity correlation coefficients. This approach addresses shortcomings of typical validation efforts that narrowly target reliability or convergent validation of single measures or single behaviors. A comprehensive method of measuring reliability, convergent validity and discriminant validity, the MBMM is a matrix of correlation coefficients between multiple assessment methods and multiple behaviors. Because it includes multiple behaviors and multiple methods, the MBMM can distinguish between variation in measurement due to the behavior and variation due to the methods. In the proposed study, the assessment methods comprise the four methods of the present invention: RE, TUD, MS-ER, and MS-VS and the multiple behaviors comprise the media-related behaviors where the four methods overlap (Table 1).

TABLE 1
Advantages and Limitations of Four Methods of Collecting Data on Media
Exposure

| | Advantages | LIMITATIONS |
|---|---|---|
| 1. Recall Estimate (RE) | Established, standardized method that can be | No media content |
| | compared to earlier studies | No exposure context |
| | Very easy and quick to collect | Social desirability bias |
| | Low burden on subjects | Very susceptible to errors of |
| | No intrusive techniques | retrieval, telescoping, |
| | Generates simple, easy-to-use data | inference, recency, salience |
| 2. Time-Use Diary (TUD) | Complete summary of subjects' 24-hour | Data collection days may not |
| | experience, including total amounts of media | be representative |
| | consumed | Priority ranking of activities |
| | Duration of media use measured | questionable |
| | Report of media content | Some susceptibility to errors |
| | Report of media use context | related to retrieval, |
| | Primary and secondary activities noted | telescoping, inference, |
| | (different than momentary attention) | recency, salience |
| | Highly correlated with observational data | Manual entry to database, |
| | | possible transcription errors |
| Momentary Sampling | “Real time” data, unalloyed by memory/revision | Requires attentive research |
| (MS) | Naturalistic portable technology allows | infrastructure |
| These general advantages | subjects to record media exposure wherever they | Cannot measure total duration |
| and limitations of MS apply | are whenever they are signaled | Can under-estimate infrequent |
| to both MS-ER and MS-VS | Records media multitasking | occurrences |
| | Minimal influence between entries - unable to | High subject burden |
| | view previous responses | Adherence can be difficult |
| 3. MS-Electronic Reports | Captures subject's focus of attention - critical | No media content, only genre |
| (MS-ER) | in a complex media environment | Handheld computer and |
| | Records context of media exposure- | programming costs |
| | identifying places, people and affective state | |
| | Automated (1) random prompts captures media | |
| | use at all times of day (2) date/time record | |
| | compares with other methods, (3) data entry | |
| | saves time, eliminates transcription errors | |
| 4. MS-Video Surveys | Comprehensive and sensitive audiovisual | Contextual information may |
| (MS-VS) | record of all media seen and/or heard, including | be seen but not identified |
| | passive or background exposure | Can only tape others if they |
| | Includes specific media content seen and/or | give permission |
| | heard images, song lyrics, URLs, subject's | Camcorder and tape costs |
| | description of what is seen and heard | |

In Table 2, a sample MBMM matrix displays correlations among three behaviors (X, Y, Z) that were assessed using two different methods (Method 1, Method 2), yielding a total of six unique variables, possibly measured at different times. The different types of correlations are denoted by different symbols. Reliability is measured by the correlations denoted by *. In the proposed study, these reliabilities will be computed as test re-test reliabilities, where the behavior and method is the same, but the assessment is made at two different time points. Convergent validity is measured by the correlations denoted by @. These figures represent correlations between the same behaviors, but measured using different assessment methods. We will compute these figures for assessments made at the same time point, though they can also be computed for different time points. Discriminant validity is measured through comparisons among correlations involving @, +, and %. + denotes the correlations between different behaviors using the same assessment method and % represents the correlations between different behaviors using different assessment methods. Discriminant validity requires that three criteria are met. First, the @s should be greater than the +s. This can be described as the correlations between the same behaviors using different assessment methods exceed the correlation between different behaviors using the same assessment method. Second, the @s should be greater than the % s from the same row or column as the @s. This can be described as the correlation between the same behavior using different assessment methods should be higher than the correlation between different behaviors using different assessment methods. Finally, the patterns of correlations within each of the sets of +s and % s should be similar across the MBMM.

TABLE 2
Multi-Behavior Multi-Method Matrix

| | | Method 1 | | | Method 2 | | |
|---|---|---|---|---|---|---|---|
| | | X₁ | Y₁ | Z₁ | X₂ | Y₂ | Z₂ |
| Method 1 | X₁ | * | | | | | |
| | Y₁ | + | * | | | | |
| | Z₁ | + | + | * | | | |
| Method 2 | X₂ | @ | % | % | * | | |
| | Y₂ | % | @ | % | + | * | |
| | Z₂ | % | % | @ | + | + | * |

*= same behavior and same method; += different behavior and same method;
@=same behavior and different method; %= different behavior and different method

Correlations assessing reliability and validity will be estimated using Pearson's Product Moment correlation coefficients and 95% confidence intervals will be constructed using Fisher's z-transformation. The reliability and convergent validity coefficients will also be tested for statistical significance using a z-test with Fisher's normalizing transformation. The form of the behavioral media variables will vary between dichotomous, ordinal, and possibly continuous representations. The correlation coefficients typically used for these measures, including point-biserial correlations, phi or Cramer's V, are mathematically equivalent to computing Pearson's Product Moment correlation on the different variable representations and retain a consistent interpretation across the measures.

The MBMM approach is a comprehensive analysis of reliability and validity that reflects the multidimensional nature of the assessment methods and the behavioral variables. Typical approaches to validation might include different assessment methods on individual behavioral measures, or alternatively, different behavioral measures with the same assessment method. The MBMM improves over these narrowly focused efforts by providing a methodological triangulation of multiple sources of measures. Evidence of low correlations can have multiple causes, including that one of the two variables is not measuring the desired behavior, neither variable is measuring the desired behavior, or that the behavior is not clearly defined. In some cases, it will be possible to define one assessment method as having criterion validity, i.e., it can be reasonably argued a priori that one assessment method will provide more valid data than the others, which will aid in interpretation. In others, the interpretation will require careful consideration of multiple factors together with the relative magnitudes of correlations across the full MBMM. Overall, the information gained from the MBMM approach will provide the best indication of which variables need clearer formulation, which variables should be replaced, and which variables are poorly assessed because of excessive or confounding method variance.

### EXAMPLE 6

### Predictive Validity

We will assess the predictive validity of media use and exposure as measured using the present invention by developing prediction models for each of the health risk behaviors and health outcomes. A prediction model for each outcome will fitted using either linear regression for interval-scale outcomes or logistic regression for nominal outcomes. The media use and exposure variables obtained with present invention will be considered as potential predictors. Relationships among groups of predictors will be evaluated prior to modeling, and data reduction using principle components analysis will be conducted to derive individual predictors from highly related groups of variables. Prediction models will be developed by regressing the health risk behavior or health outcome on the media use and exposure predictors. Sex and age of the subject will be included in all of the models. The best subset of potential predictors will be selected using backward elimination according to the largest reduction in the value of the AIC. After the predictive models have been developed, a detailed analysis of residuals and other diagnostics for each model will be performed to check distributional assumptions and identify outliers. Linearizing or variance stabilizing transformation will be made as appropriate.

One potential problem with backward elimination or any stepwise procedure is overfitting, that is, that the model performs well on the data used to estimate it but not future data. This problem is potentially exacerbated with modest sample sizes and multiple predictors. To address this problem, a bootstrap approach to shrinkage for generalized linear models proposed by Harrell will be applied to each predictive model. This approach draws a sample from the original data, fits the selected model to the sample, then estimates additive and multiplicative adjustments to the linear predictor that result in optimum prediction in the original data. The values of the additive and multiplicative adjustments to the linear predictor are taken to be the average over all replications. These adjustments are then applied to the original estimated parameters to arrive at final optimal predictive models.

It is understood that the disclosed invention is not limited to the particular methodology and protocols as these may vary. It is also to be understood that the terminology used herein is for the purpose of describing particular embodiments only, and is not intended to limit the scope of the present invention which will be limited only by the appended claims.

It must be noted that as used herein and in the appended claims, the singular forms “a”, “an”, and “the” include plural reference unless the context clearly dictates otherwise. Unless defined otherwise, all technical and scientific terms used herein have the same meanings as commonly understood by one of skill in the art to which the disclosed invention belongs. Although any methods and materials similar or equivalent to those described herein can be used in the practice or testing of the present invention, the preferred methods, devices, and materials are as described. Publications cited herein and the material for which they are cited are specifically incorporated by reference. Nothing herein is to be construed as an admission that the invention is not entitled to antedate such disclosure by virtue of prior invention.

Those skilled in the art will recognize, or be able to ascertain using no more than routine experimentation, many equivalents to the specific embodiments of the invention described herein. Such equivalents are intended to be encompassed by the following claims.

1. A method for measuring the effects of media exposure on a subject, the method comprising the steps of:
(a) performing a recall estimate of a subject exposed to the medium;
(b) providing a time-use diary of the activities of the subject during exposure to the medium;
(c) performing a momentary sampling of the subject during exposure to the medium; and
(d) acquiring the complete audio and visual environment of the subject during exposure to the medium,
wherein the effects of media exposure on the subject is determined by attention of the subject to the medium and the effect of the environment on the subject to the medium.

2. The method of claim 1, wherein the effects of media exposure determine salience of the medium.

3. The method of claim 2, wherein the salience of the medium is determined by attention of the subject to the medium and the effects of the environment on the subject to the medium.

4. The method of claim 3, wherein the salience of the medium is used to determine the placement of advertising a specific population.

5. The method of claim 1, wherein the method predicts a behavioral outcome based on exposure to a specific medium.

6. The method of claim 5, wherein the behavioral outcome is dietary habits.

7. The method of claim 5, wherein the behavioral outcome is exercise habits.

8. The method of claim 5, wherein the behavioral outcome is propensity to express violent behavior.

9. The method of claim 5, wherein the behavioral outcome is consumer behavior.

10. The method of claim 1, wherein the method measures the subject's attention to specific media sources in a media rich environment.

11. A method for measuring effects of media exposure on a subject, the method operable using at least one processor and comprising:
(a) generating a first notification to alert the subject to complete a time use diary (TUD) within a specified period of time;
(b) displaying a first form to receive TUD data;
(c) generating a second notification to alert the subject to record momentary media exposure data;
(d) displaying a second form to receive momentary media exposure data;
(e) generating a third notification to alert the user to record video data of an environment in which the subject is exposed to media;
(f) receiving the video data of the environment;
(g) assigning a weighting to each of the TUD data, the momentary media exposure data, the video data, and the recall estimate data; and
(h) determining a value for a media exposure assessment parameter as a function of the assigned weightings.

12. The method of claim 11, wherein the method measures salience of the medium.

13. The method of claim 12, wherein the salience of the medium is determined by attention of the subject to the medium and the effects of the environment on the subject to the medium.

14. The method of claim 13, wherein the data from (g) and (h) are analyzed using regression analysis.

15. The method of claim 14, wherein (a)-(f) are performed during a one-week period.

16. The method of claim 15, wherein a handheld computer is used to randomly signal when the subject's activities are to be recorded in the TUD, and wherein the random signals generated by the handheld computer double in frequency on days in which the subject is signaled to record the activities in the TUD.

17. The method of claim 16, wherein the salience of the medium is used to determine the placement of advertising a specific population.

18. The method of claim 11, wherein the method predicts a behavioral outcome based on exposure to a specific medium.

19. The method of claim 18, wherein the behavioral outcome is dietary habits.

20. The method of claim 18, wherein the behavioral outcome is exercise habits.

21. The method of claim 18, wherein the behavioral outcome is propensity to express violent behavior.

22. The method of claim 18, wherein the behavioral outcome is consumer behavior.

23. The method of claim 11, wherein the method measures the subjects attention to specific media sources in a media rich environment.

24. The method of claim 23, wherein the data from (g) and (h) are analyzed using regression analysis.

25. The method of claim 24, wherein (a)-(f) are performed during a one-week period.

26. The method of claim 25, wherein a handheld computer is used to randomly signal when the subject's activities are to be recorded in the TUD, and wherein the random signals generated by the handheld computer double in frequency on days in which the subject is signaled to record the activities in the TUD.

27. The method of claim 26, wherein the salience of the medium is used to determine the placement of advertising a specific population.

28. The method of claim 27, wherein the method predicts a behavioral outcome based on exposure to a specific medium.

29. A system for measuring effects of media exposure on a subject, the system comprising:
(a) a media exposure application executable on a portable computing device, the media exposure application comprising:
(i) a notification module to generate a first notification to alert the subject to complete a time use diary (TUD) within a specified period of time, to generate a second notification to alert the subject to record momentary media exposure data, and to generate a third notification to alert the user to record a video of an environment in which the subject is exposed to media; and
(ii) a user interface module to generate a first form for display in response to the first notification, to generate a second form for display in response to the second notification, and to generate a third form for display in response to user input, wherein the first form is configured to receive TUD data, the second form is configured to receive momentary media exposure data, and the third form is configured to receive recall estimate data;
(b) an assessment application executable on a processing system and configured to receive video data of the environment in which the subject is exposed to the media, the assessment application comprising:
(i) a retrieval module to retrieve the TUD data, the momentary media exposure data, and the recall estimate data from the portable computing device and to receive the video data; and
(ii) an assessment module to assign a weighting to each of the TUD data, the momentary media exposure data, the video data, and the recall estimate data and to determine a value for a media exposure assessment parameter as a function of the assigned weightings.

30. A system for measuring effects of media exposure on a subject, the system comprising:
a) a portable computing device comprising:
i) a media exposure application executable on the portable computing device, the media exposure application comprising:
(1) a notification module to generate a first notification signal to alert the subject to complete a time use diary (TUD) within a specified period of time, to generate a second notification signal to alert the subject to record momentary media exposure data, and to generate a third notification signal to alert the user to record a video of an environment in which the subject is exposed to media; and
(2) a user interface module to generate a first form for display in response to the first notification signal, to generate a second form for display in response to the second notification signal, and to generate a third form for display in response to user input, wherein the first form is configured to receive TUD data, the second form is configured to receive momentary media exposure data, and the third form is configured to receive recall estimate data; and
ii) a video capture component to capture video data of an environment in which the subject is exposed to the media; and
b) a processing system computer comprising an assessment application executable on the processing computer, the assessment application comprising:
i) a retrieval module to retrieve TUD data, momentary media exposure data, video data, and the recall estimate data from the portable computing device for storage in a memory; and
ii) an assessment module to assign a weighting to each of the TUD data, the momentary media exposure data, the video data, and the recall estimate data and to determine a value for a media exposure assessment parameter as a function of the assigned weighting.
